(19) United States
(12) Patent Application Publication
(10) Pub. No.: US 2014/0192545 A1
(43) Pub. Date: Jul. 10, 2014

(54) Aerodynamic Spoiler For Pickup Truck With LED Lights

(71) Applicants: Calvin Cheuen Kam Law, Chino, CA (US); George Lee, Brea, CA (US)

(72) Inventors: Calvin Cheuen Kam Law, Chino, CA (US); George Lee, Brea, CA (US)

(21) Appl. No.: 13/737,841

(22) Filed: Jan. 9, 2013

(51) Int. Cl. B60Q 1/00

(52) U.S. Cl. CPC B60Q 1/0017
USPC 362/485

(57) ABSTRACT

An aerodynamic spoiler adapted to be mounted on the tailgate of a pickup truck to enhance under certain driving conditions and to reduce turbulence in the cargo box and having LED lights having the functions of brake light, signal turn light, reverse light, and tail light, with power and signals fed from the original lights within the truck.

### INCORPORATION BY REFERENCE

This application claims the benefit of priority under 35 U.S.C. 119(e) to the filing date of U.S. provisional patent application No. 61/717,783 “Aerodynamic Spoiler For Pickup Truck With LED Lights” which was filed on Oct. 24, 2012, and which is incorporated herein by reference in its entirety.

### FIELD OF THE INVENTION

The present invention relates to an aerodynamic spoiler for a pickup truck and a method for facilitating the provision of such aerodynamic spoilers for pickup trucks of various makes and models and further an aerodynamic spoiler having LED lights with power and signals extending from the original lighting system of the vehicle.

### BACKGROUND OF THE INVENTION

Aerodynamic wings or spoilers have been used on numerous vehicles, including race cars and passenger cars, to enhance the stability of the vehicles under certain driving conditions. In fact, various types of air spoiler device have been known such as (1) those intended for reducing resistance of air or reducing lift acting on the body of the automobile, (2) those intended for preventing front or rear window from being dirty with dust or rain, and, for trucks, (3) those intended for preventing damage to the tailgate of the truck.

Spoiler devices have been known to make positive use of stream of air along automobiles to ensure stability during running of the automobile. The use of aerodynamic spoilers to reduce drag or resistance of air acting on the body of the automobile results in an increase in speed of the vehicle. Furthermore, spoilers can also reduce lift acting on the body of the automobile. This creates a downward force on the tires to increase the amount of traction they have on the driving surface. The spoilers do this by manipulating the air flow around a moving vehicle when the air encounters the surface of the spoiler. This increase in traction gives the driver more control in maneuvering the vehicle.

Additionally, spoilers may also be used to prevent the front or rear window from being dirty with dust or rain. More specifically to trucks, it has been discovered that the use of a spoiler on the tailgate of a pickup truck not only enhances stability but also significantly reduces turbulence in the cargo box behind the vehicle cab. The turbulence can result in dirt, dust, and other debris from the cargo box being drawn into the cab through its rear window and thus requiring the window to be closed when driving. The aerodynamic spoiler of the present invention can minimize such turbulence and thus allows the vehicle to be driven with the rear window open.

Moreover, frequently, the vehicle is operated with the tailgate down; this can result in scraping or marring of the tailgate. The aerodynamic spoiler of the present invention can be constructed of a hard, durable plastic that can normally withstand the type of use that would ordinarily damage the tailgate. Thus the use of an aerodynamic spoiler on the tailgate can protect the tailgate from such damage.

Over the last few years, Light Emitting Diodes (LEDs) lighting systems for vehicles have seen an increase in demand as consumers seek novel ways to accessorize and customize their vehicles while also gaining added safety. LED-based lighting systems are becoming very popular for several reasons: light-emitting diodes are small, completely solid state, very power-efficient, and have very long lives having no filaments to burn out. These LED lighting systems work as running lights, brake lights, turn signals, and reverse lights, as well as for cosmetic purposes. Therefore, the use of LEDs as illuminating source is ideal for such application.

What is needed is a truck lighting system which can accomplish one or more of the following: (i) effectively provide better control and maneuverability of the vehicle through improved aerodynamics; (ii) effectively provide reduce drag or resistance of the air flowing through the vehicle to increase speed and reduce gasoline consumption; (iii) effectively reduce turbulence in the cargo cab of the vehicle to prevent dirt and other debris from entering the cab through the rear windows; (iv) will not impede the use of the entire space of the truck bed nor distract from the intended aesthetic design of the truck; and (v) can be easily installed either in the factory or after market without modification to the design of the truck.

The present invention provides for an aerodynamic spoiler that accomplishes the above and also provides additional, improved functionality. An aerodynamic spoiler with an electrical LED lighting system provides all the improvements and benefits as mentioned above. Furthermore, the spoiler can be installed and use as an after-market accessory with a variety of vehicles. As such, ease of installation of the aerodynamic spoiler with electrical lighting system makes the present invention efficient and effective for consumers.

### OBJECT OF THE INVENTION

Therefore, it is an object of the present invention disclosed herein to provide a novel spoiler for use on the tailgate of a pickup truck.

It is another object of the present invention to provide a novel having the function of making the vehicle more aerodynamic through reducing drag or resistance of air acting on the body of the automobile, thereby, increasing the speed of the vehicle

It is another object of the present invention to provide a novel, aerodynamic spoiler that enhances driving conditions through reducing resistance of air or reducing lift acting on the body of the automobile, and thereby, increase of downward force on the tires to increase the amount of traction they have on the driving surface control in maneuvering the vehicle.

It is another object of the present invention to provide a novel, aerodynamic spoilers having lights, wherein the illuminating source is preferably light-emitting-diodes (LEDs).

It is another object of the present invention to provide a novel, aerodynamic spoiler having LED lights for use on the mounting surface of various different makes and models of vehicles.

It is another object of the present invention to provide a novel, aerodynamic spoiler having LED lights with power and signals fed from the original lights of the vehicle.

It is another object of the present invention to provide a novel, aerodynamic spoiler having LED lights having the functions of brake light, signal turn light, reverse light, and tail light.

It is another object of the present invention to provide a novel, aerodynamic spoiler having LED lights in order to reduce and minimize turbulence in the vehicle's cargo box.

It is another object of the present invention to provide a novel, aerodynamic spoiler having LED lights to easily and efficiently accessorize and customize their vehicles

It is another object of the present invention to provide a novel, aerodynamic spoiler having LED lights in order to illuminate the vehicle to other and provide added safety.

It is another object of the present invention to provide a novel, aerodynamic spoiler having LED lights that does not interfere with the functionality of the vehicle's tailgate.

It is another object of the present invention to provide a novel, aerodynamic spoiler having LED lights that is easy to install as an after-market accessory for installing on a variety of vehicles.

### SUMMARY OF THE INVENTION

A spoiler apparatus is disclosed comprising a wing apparatus wherein the wing apparatus is comprised of one of more vehicle signal light units wherein the spoiler apparatus is suitable to mount on a truck's tailgate. In one embodiment, the spoiler apparatus is suitable to mount onto the tailgate's upper edge. In one embodiment, the vehicle signal light units are comprised of brake lights and turn signal lights. In one embodiment, the vehicle signal lights are further comprised of reverse lights and tail lights. In one embodiment, the vehicle signal lights are LED lights. In one embodiment, the apparatus further comprising a connection apparatus wherein the connection apparatus connects the vehicle signal light units to at least one cable wherein the cable is connected to the vehicle's tail light unit. In another aspect of the invention, a method to provide vehicle signal lights to a truck spoiler is disclosed comprising providing a spoiler apparatus comprising a wing apparatus wherein the wing apparatus is comprised of one of more vehicle signal light units wherein the spoiler apparatus is suitable to mount on a truck's tailgate. In one embodiment, the spoiler apparatus is suitable to mount onto the tailgate's upper edge. In one embodiment, the vehicle signal light units are comprised of brake lights and turn signal lights. In one embodiment, the vehicle signal lights are further comprised of reverse lights and tail lights. In one embodiment, the vehicle signal lights are LED lights. In one embodiment, the method further comprising a connection apparatus wherein the connection apparatus connects the vehicle signal light units to at least one cable wherein the cable is connected to the vehicle's tail light unit.

### BRIEF DESCRIPTIONS OF THE DRAWINGS

Other objects, features, and advantages of the present invention will become apparent from the subsequent description and the appended claims, taken in conjunction with the accompanying drawings, in which:

FIG. 1 is a schematic illustration in perspective view of an embodiment of the aerodynamic spoiler adapted to be mounted on the tailgate of a pickup truck and further includes an electrical lighting system of a vehicle typically includes brake and turn signal lights mounted on the rear of the vehicle for indicating vehicle braking, reversing, or directional changes.

FIG. 2 is a schematic illustration in front view of an embodiment of the aerodynamic spoiler adapted to be mounted on the tailgate of a pickup truck and further includes an electrical lighting system of a vehicle typically includes brake and turn signal lights mounted on the rear of the vehicle for indicating vehicle braking, reversing, or directional changes.

FIG. 3 is a schematic illustration in top view of an embodiment of the aerodynamic spoiler adapted to be mounted on the tailgate of a pickup truck and further includes an electrical lighting system of a vehicle typically includes brake and turn signal lights mounted on the rear of the vehicle for indicating vehicle braking, reversing, or directional changes.

FIG. 4 is a perspective view of one of the embodiment of the present invention as installed on a truck tailgate.

### DETAIL DESCRIPTION OF THE INVENTION

The present invention is an easy-to-install, aerodynamic spoiler having LED lights with power and signals extending from the original lighting system of the vehicle. In the following description, specific details are set forth in order to provide a more thorough description of the present invention. It will be apparent, however, to one skilled in the art, that the present invention may be practice without the specific details. In other instances, well-known features have not been described in detail so as not to obscure the invention.

The present invention comprises a spoiler suitable for after-market installation on a variety of vehicles. More particularly, the spoiler can be installed as an after-market accessory on trucks for a multitude of purposes, including, but not limited to, enhancing the stability of the vehicles under certain driving conditions. The spoiler can make positive use of stream of air along automobiles to provide increased stability during maneuvering of the automobile. The use of the spoiler allows the vehicle to be more aerodynamic, and thus, more easily controlled and driven. The increase in maneuverability of the vehicle stems mainly from two areas: (1) reducing drag or resistance of air against the automobile and (2) increasing the traction between the tires and driving surface.

Drag or resistance is the natural reaction of the air to resist the motion of the automobile through the air. Therefore, drag or resistance of air acting against the automobile can result in a reduction of speed as well as an increase is gasoline consumption. The use of spoilers, however, can reduce drag or resistance of air that is acting on the body of the automobile. The spoiler can, through aerodynamics, decrease such drag or resistance of the air. As such, spoilers can be used to increase the speed of the vehicle as well as reduce the consumption of gasoline through reduction of drag or resistance of the air.

Furthermore, spoilers can also reduce lift acting on the body of the automobile. Lift is the force that is perpendicular to the oncoming air flow direction that can cause the vehicle to be raised up. This reduces the contact area between the vehicle tires and the driving surface, and thereby, reducing the grip of the tires on the road and therefore the control of the driver over the maneuvering of the vehicle. Without spoilers, the only way to increase the grip would be to increase the weight, or to change the compound the tire was made out of. The problem with increasing the weight of the vehicle is that it doesn't help the vehicle in maneuvering turns, where traction is especially important and necessary. Furthermore, all that extra weight has inertia, which needs to be overcame in order to maneuver a turn. Therefore, increasing the weight doesn't solve the issue of lift on a vehicle as it increases in speed. Spoilers, however, can counter the issue of lift on a vehicle. More specifically, the spoilers do this by manipulating the air flow around a moving vehicle when the air encounters the surface of the spoiler. As a result, the spoilers create a downward force on the tires to increase the amount of traction they have on the driving surface. This increase in traction gives the driver more control in maneuvering the vehicle.

Furthermore, it has been discovered that the use of a spoiler not only enhances the stability of the vehicle for maneuvering, but also significantly reduces turbulence cause by the air flowing through the vehicle at high speeds. More specifically, the spoiler can be installed on the tailgate of a pickup truck to enhance stability and to reduce turbulence in the cargo box behind the vehicle cab. The turbulence results in dirt, dust, etc. from the cargo box being drawn into the cab through its rear window thus routinely requiring the window to be closed when driving. The aerodynamic spoiler of the present invention minimizes such turbulence, and therefore, minimizes dirt, dust, etc. from entering the vehicle through the rear windows. As such, installation of the aerodynamic spoiler permits the vehicle to be driven with the rear window open.

Moreover, the aerodynamic spoiler also includes an electrical lighting system that serves as an extension of the vehicle's original lighting system for safety and aesthetic purposes. Typically, a vehicle includes brake and turn signal lights mounted on the rear of the vehicle for indicating vehicle braking, reversing, or directional changes. Illuminated brake lights also indicate a slowing or stopping vehicle, illuminated and flashing turn signal lights indicate a turning vehicle, and additional illuminated lights indicate a reversing vehicle. In late model vehicles, the turn signal lights and brake lights are independently connected to the electrical lighting system of the towing vehicle and have separate filaments. The brake light filament is typically connected directly to the vehicle brake, while the turn signal light filament is typically connected directly to the turn signal indicator. Preferably, the illuminating source of the electrical lighting system of the aerodynamic spoiler is from a light-emitting-diode (LED). The electrical lighting system of the aerodynamic spoiler can be powered and its signals fed by the original electrical lighting system of the vehicle.

More specifically, the LED lighting system is installed, via the aerodynamic spoiler, to the tailgate of the vehicle and connected to a vehicle's standard electrical connector. The LED lighting system can reproduce the appropriate light sequence that built-in lights on the rear of the vehicle would produce for a given situation: (1) illuminated lights as running lights by default; (2) illuminated brake lights also indicate a slowing or stopping vehicle; (3) illuminated and flashing turn signal lights indicate a turning vehicle; and (4) additional illuminated lights indicate a reversing vehicle. These LEDs create a “safety zone” behind the vehicle for safe, confident maneuvering.

In the present invention disclosed herein, the aerodynamic spoiler not only reduces turbulence and improves the aerodynamics to provide better control and maneuvering of the vehicle, reduce gasoline consumption, and increase speed, the electrical LED lighting system also provides improved safety and aesthetics. Consumers will be able to install the aerodynamic spoiler with LED lights as an after-market accessory easily for a variety of trucks.

It will be apparent from the following description which should be read together with the accompanying drawings that there are other advantages of the present invention as is apparent from the disclosed preferred embodiments of the various forms of this invention and that the accompanying detailed description should be read as not limiting the present invention, but as explaining the same.

### DETAIL DESCRIPTION OF THE DRAWINGS

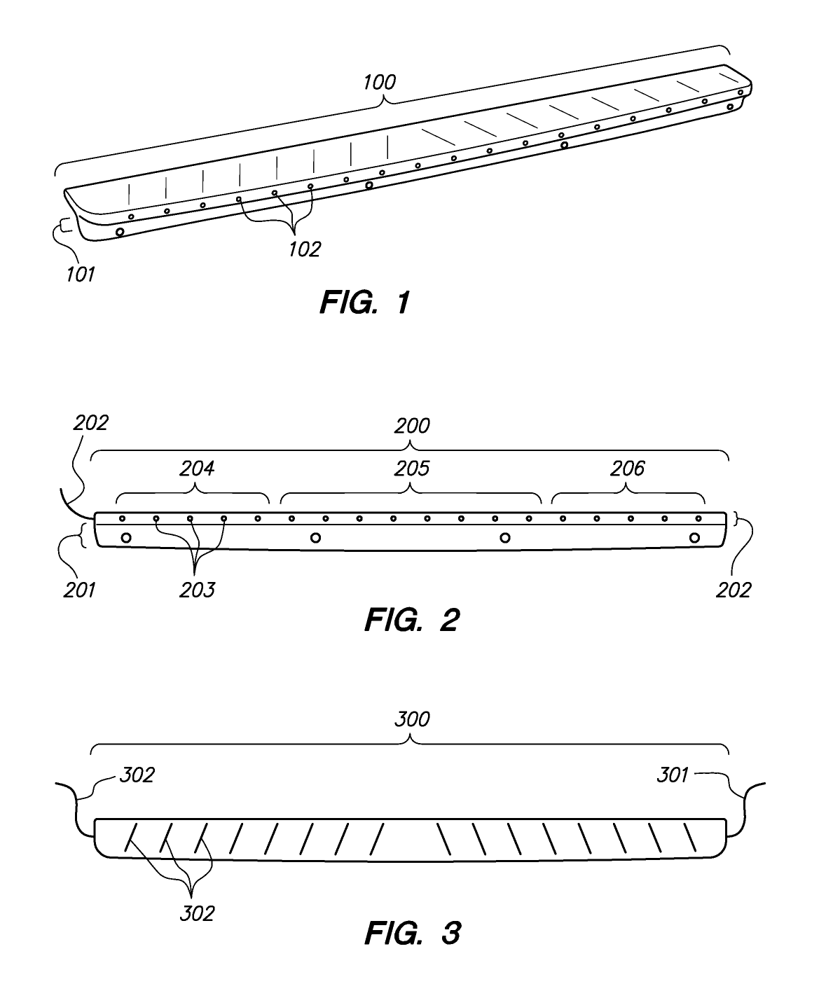

Referring to the drawings which illustrate preferred forms of the present invention, FIG. 1 is a schematic illustration in perspective view of an embodiment of the aerodynamic spoiler 100 as described above. The aerodynamic spoiler 100 is adapted to be mounted on a variety of vehicles, and more specifically on the tailgate of a pickup truck. The aerodynamic spoiler 101 further includes an electrical lighting system for use on a vehicle. The electrical lighting system 101 is comprised of LEDs 102, wherein the illumination of the electrical LED lighting system functions as brake lights, reverse lights and turn signal lights. The lighting system 101 is connected via electrical wires 103 to the original electrical lighting system of the vehicle in order to draw electricity and signal information from the vehicle. Therefore, the electrical LED 102 lighting system 101 is mounted on the tailgate of the truck for indicating vehicle braking, reversing, or changing directions.

FIG. 2 is a schematic illustration of the front view of an embodiment of the aerodynamic spoiler 200 with an electrical LED lighting system 201. The aerodynamic spoiler 200 can be mounted on the tailgate of the truck, and the electrical LED lighting system 201 can be connected via electrical wires and/or adapters 202 to the electrical lighting system of the truck. Furthermore, the LED lights 203 can illuminated together or separately in a systematic manner as signal lights. For example, the LED lights in 204 can serve as the left turn signal light indicator, the LED lights in 205 can serve as the vehicle reverse light indicator, and the LED lights in 206 can serve as the right turn signal light indicator.

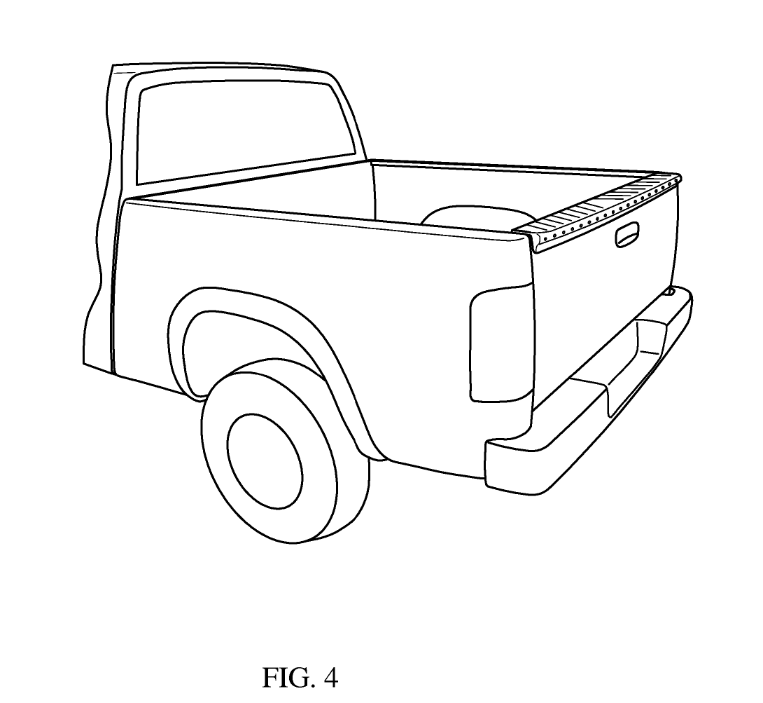

FIG. 3 is a schematic illustration in top view of the aerodynamic spoiler 300 adapted to be mounted on the tailgate of a pickup truck. The aerodynamic spoiler 300 can be mounted on the tailgate of the truck, and the electrical LED lighting system can be connected via electrical wires and/or adapters 301 to the electrical lighting system of the truck. The top of the aerodynamic spoiler has indentations 302 that function to manipulate the air flow around the moving vehicle when the air encounters the surface of the spoiler to provide better aerodynamics. More specifically, the spoiler 300 makes positive use of stream of air along automobiles to ensure stability during running of the automobile. The aerodynamic spoilers 300 with its indentations 302 reduces drag or resistance of air acting on the body of the automobile to increase in speed of the vehicle. Furthermore, the spoiler 300 with its indentations 302 can also reduce lift acting on the body of the automobile. This creates a downward force on the tires to increase the amount of traction they have on the driving surface. This increase in traction gives the driver more control in maneuvering the vehicle.

FIG. 4 is a perspective view of one of the embodiment of the present invention as installed on a truck tailgate. 401 shows one embodiment of the spoiler apparatus of the present invention as mounted on the truck's tailgate. 402 shows the edge of the truck's tailgate which the spoiler apparatus 401 is mounted on. 403 shows the vehicle signal lights as installed on the spoiler apparatus 401. Also disclosed is the truck's taillight 404, which is operated by a set of cables leading from the vehicle which instructs the taillight to operate its reverse light, its turn signal lights, and it night light. In one embodiment, the spoiler apparatus 401 has a connection device connecting to the cable that is connected to the vehicle taillight 404 which in essence the spoiler apparatus's vehicle signal light 403 operates simultaneously similar to the vehicle's taillight 404.

1. A spoiler apparatus comprising a wing apparatus wherein said wing apparatus is comprised of a vehicle signal light unit wherein said spoiler apparatus is suitable to mount on a truck's tailgate wherein said spoiler is comprised of a leading slab wherein said leading slab is comprised of a leading edge facing away from said truck's tailgate wherein said vehicle signal light unit is consist of a plurality of equally spaced LED lights positioned along the entire length of said leading edge wherein said equally spaced LED lights are comprised of a left group LED lights 204, a center group LED lights 205 and a right group LED lights 206 wherein said left group LED lights 204 function as left signal light, said center group LED lights 205 function as reverse light and said right group LED lights 206 function as right signal light.

2-6. (canceled)

7. A method to provide vehicle signal lights to a truck spoiler comprising providing a spoiler apparatus comprising a wing apparatus wherein said wing apparatus is comprised of one of more vehicle signal light units wherein said spoiler apparatus is suitable to mount onto said tailgate's upper edge wherein said spoiler is comprised of a leading slab wherein said leading slab is comprised of a leading edge facing away from said truck's tailgate wherein said vehicle signal light unit is consist of a plurality of equally spaced LED lights positioned along the entire length of said leading edge wherein said equally spaced LED lights are comprised group LED lights 204, a center group LED lights 205 and a right group LED lights 206 wherein said left group LED lights 204 function as left signal light, said center group LED lights 205 function as reverse light and said right group LED lights 206 function as right signal light.

8-12. (canceled)
